(19) United States
(12) Patent Application Publication
(10) Pub. No.: US 2012/0213336 A1
(43) Pub. Date: Aug. 23, 2012

(54) MULTIPLE-SIZE SUPPORT FOR X-RAY WINDOW

(76) Inventor: Steven Liddiard, Springville, UT (US)

(21) Appl. No.: 13/312,531

(22) Filed: Dec. 6, 2011

Related U.S. Application Data
(60) Provisional application No. 61/445,878, filed on Feb. 23, 2011.

(51) Int. Cl. G21K 1/00

(52) U.S. Cl. 378/161

(57) ABSTRACT

An x-ray window including a support frame with a perimeter and an aperture. A plurality of ribs can extend across the aperture of the support frame and can be supported or carried by the support frame. Openings exist between ribs to allow transmission of x-rays through such openings with no attenuation of x-rays by the ribs. A film can be disposed over and span the ribs and openings. The ribs can have at least two different cross-sectional sizes including at least one larger sized rib with a cross-sectional area that is at least 5% larger than a cross-sectional area of at least one smaller sized rib.

### CLAIM OF PRIORITY

This claims priority to U.S. Provisional Patent Application Ser. No. 61/445,878, filed Feb. 23, 2011, which is incorporated herein by reference in its entirety.

### BACKGROUND

X-ray windows can be used for enclosing an x-ray source or detection device. The window can be used to separate air from a vacuum within the enclosure while allowing passage of x-rays through the window.

X-ray windows can include a thin film supported by a support structure, typically comprised of ribs supported by a frame. The support structure can be used to minimize sagging or breaking of the thin film. The support structure can interfere with the passage of x-rays and thus it can be desirable for ribs to be as thin or narrow as possible while still maintaining sufficient strength to hold the thin film. The support structure is normally expected to be strong enough to withstand a differential pressure of around 1 atmosphere without sagging or breaking.

Information relevant to x-ray windows can be found in U.S. Pat. Nos. 4,933,557, 7,737,424, 7,709,820, 7,756,251 and U.S. patent application Ser. Nos. 11/756,962, 12/783,707, 13/018,667, 61/408,472 all incorporated herein by reference.

### SUMMARY

It has been recognized that it would be advantageous to provide a support structure for an x-ray window that is strong but also minimizes attenuation of x-rays. The present invention is directed to an x-ray window that satisfies the need for strength and minimal attenuation of x-rays by providing larger ribs for strength of the overall structure which support smaller ribs. The smaller ribs allow for reduced attenuation of x-rays. The x-ray window can comprise a support frame with a perimeter and an aperture. A plurality of ribs can extend across the aperture of the support frame and can be supported or carried by the support frame. Openings exist between ribs to allow transmission of x-rays through such openings with no attenuation of x-rays by the ribs. A film can be disposed over and span the ribs and openings. The film can be configured to pass radiation therethrough, such as by selecting a film material and thickness for optimal transmission of x-rays. The ribs can have at least two different cross-sectional sizes including at least one larger sized rib with a cross-sectional area that is at least 5% larger than a cross-sectional area of at least one smaller sized rib.

### BRIEF DESCRIPTION OF THE DRAWINGS

FIG. 1 is a schematic cross-sectional side view of an x-ray window, showing a thin film supported by a support structure, in accordance with an embodiment of the present invention;

FIG. 2 is a schematic top view of an x-ray window support structure, with some ribs having a larger cross-sectional area and other ribs having a smaller cross-sectional area, in accordance with an embodiment of the present invention;

FIG. 3 is a schematic top view of an x-ray window support structure, with some ribs having a larger cross-sectional area and other ribs having a smaller cross-sectional area, in accordance with an embodiment of the present invention;

FIG. 4 is a schematic top view of an x-ray window support structure, with some ribs having a larger cross-sectional area and other ribs having a smaller cross-sectional area, in accordance with an embodiment of the present invention;

FIG. 5 is a schematic top view of an x-ray window support structure, with some ribs having a larger cross-sectional area and other ribs having a smaller cross-sectional area, in accordance with an embodiment of the present invention;

FIG. 6 is a schematic top view of an x-ray window support structure, with some ribs having a larger cross-sectional area and other ribs having a smaller cross-sectional area, in accordance with an embodiment of the present invention;

FIG. 7 is a schematic top view of an x-ray window support structure, with some ribs having a larger cross-sectional area and other ribs having a smaller cross-sectional area, in accordance with an embodiment of the present invention;

FIG. 8 is a schematic top view of an x-ray window support structure, with some ribs having a larger cross-sectional area and other ribs having a smaller cross-sectional area, in accordance with an embodiment of the present invention;

FIG. 9 is a schematic top view of an x-ray window support structure, with some ribs having a larger cross-sectional area and other ribs having a smaller cross-sectional area, in accordance with an embodiment of the present invention;

FIG. 10 is a schematic cross-sectional side view of an x-ray detector and x-ray window, in accordance with an embodiment of the present invention;

FIG. 11 is a schematic cross-sectional side view of an x-ray tube and x-ray window, in accordance with an embodiment of the present invention; and

FIG. 12 is schematic cross-sectional side view of an x-ray window, showing a thin film supported by a support structure, in accordance with an embodiment of the present invention.

### DEFINITIONS

As used herein, the term “about” is used to provide flexibility to a numerical range or value by providing that a given value may be “a little above” or “a little below” the endpoint.
As used herein, the term rib “cross-sectional area” means the rib width times the rib height.
As used herein, the term “linear” or “linearly”, as referring to the rib pattern, means that the rib or ribs extends substantially straight, without bends or curves, as the rib extends across the aperture of the support frame. “Non-linear” means that the rib does bend or curve.
As used herein, the terms “larger ribs,” “larger rib,” “largest ribs,” and “largest rib” mean larger or largest in cross-sectional area of the ribs, and does not refer to the length of the ribs.
As used herein, the terms “smaller ribs,” “smaller rib,” “smallest ribs,” and “smallest rib” mean smaller or smallest in cross-sectional area of the ribs, and does not refer to the length of the ribs.
As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

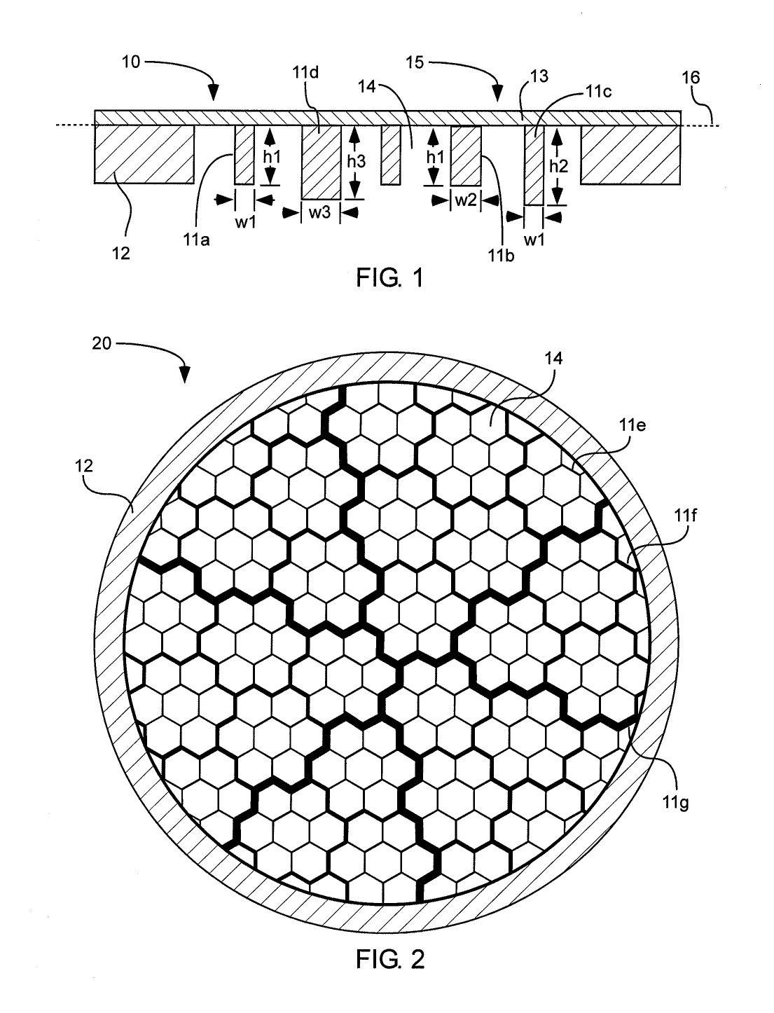

As illustrated in FIG. 1, an x-ray window 10 is shown comprising a support frame 12 with a perimeter and an aperture 15. A plurality of ribs 11 can extend across the aperture 15 of the support frame 12 and can be supported or carried by the support frame 12. Openings 14 exist between ribs 11 to allow transmission of x-rays through such openings with no attenuation of x-rays by the ribs 11. A film 13 can be disposed over and span the ribs 11 and openings 14. The film 13 can be carried by the ribs 11. The film 13 can contact the ribs 11.

The film 13 can be configured to pass radiation therethrough, such as by selecting a film material and thickness for optimal transmission of x-rays. The ribs 11 can have at least two different cross-sectional sizes including at least one larger sized rib with a cross-sectional area that is at least 5% larger than a cross-sectional area of at least one smaller sized rib. This design with some ribs having a larger cross sectional area and other ribs having a smaller cross sectional area can have high strength provided by the larger ribs while allowing for minimal attenuation of x-rays by use of smaller ribs.

The change in cross-sectional area between larger and smaller ribs can be accomplished by a change in rib width w and/or a change in rib height h. For example, in FIG. 1, rib 11b has a width w2 that is greater than a width w1 of rib 11a, but both ribs have approximately equal heights h1, and thus rib 11b has a greater cross-sectional area than rib 11a. As another example, rib 11c has a height h2 that is greater than a height h1 of rib 11a, but both ribs have approximately equal widths w1, and thus rib 11c has a greater cross-sectional area than rib 11a. As another example, rib 11d has a height h3 that is greater than a height h1 of rib 11a and a width w3 that is greater than a width w1 of rib 11a, and thus rib 11d has a greater cross-sectional area than rib 11a. As another example not shown, one rib may have a greater width, but a lesser height, than another rib. Whichever rib has a greater value of width times height has a greater cross-sectional area.

In the various embodiments described herein, tops of the ribs 11 can terminate substantially in a common plane 16. “Tops of the ribs” is defined as the location on the ribs 11 to which the film 13 is attached. It can be beneficial for tops of the ribs 11 to terminate substantially in a common plane 16 to allow for a substantially flat film 13.

FIGS. 2-9 show schematic top views of x-ray window support structures, with some ribs having a larger cross-sectional area and other ribs having a smaller cross-sectional area. Ribs with a smallest cross-sectional area are designated as 11e, ribs with a larger cross-sectional area than ribs 11e are designated as 11f, ribs with a larger cross-sectional area than ribs 11f are designated as 11g, ribs with a larger cross-sectional area than ribs 11g are designated as 11h, and ribs with a larger cross-sectional area than ribs 11h are designated as 11i. Ribs with larger cross-sectional area are shown with wider lines. A wider line does not necessarily mean that the rib is wider, only that the cross-sectional area is larger, which may be accomplished by a larger width, a larger height, or both, than another rib.

In one embodiment, each larger sized rib can have a cross-sectional area that is at least 5% larger than a cross-sectional area of smaller sized ribs

$$\frac{Area of larger rib - Area of smaller rib}{Area of smaller rib} > 0.05 .$$

In another embodiment, each larger sized rib can have a cross-sectional area that is at least 10% larger than a cross-sectional area of smaller sized ribs. In another embodiment, each larger sized rib can have a cross-sectional area that is at least 25% larger than a cross-sectional area of smaller sized ribs. In another embodiment, each larger sized rib can have a cross-sectional area that is at least 50% larger than a cross-sectional area of smaller sized ribs. In another embodiment, each larger sized rib can have a cross-sectional area that is at least twice as large as a cross-sectional area of smaller sized ribs. In another embodiment, each larger sized rib can have a cross-sectional area that is at least four times as large as a cross-sectional area of smaller sized ribs.

Some figures show only two different cross-sectional area size ribs, but more cross-sectional area sizes are within the scope of the present invention and are only excluded from the figures for simplicity. Also, more than the five different cross-sectional area size ribs shown are within the scope of the present invention and are only excluded from the figures for simplicity.

As illustrated in FIG. 2, an x-ray window 20 is shown with ribs 11e-g having at least three different cross-sectional areas. The smallest ribs 11e are formed into repeating hexagonal shapes and define hexagonal-shaped openings. The next larger ribs 11f are formed into repeating structures comprising seven of the small hexagonal shapes. The pattern of the larger ribs 11f can be aligned with the part of the hexagonal pattern of the smaller sized ribs 11e.

Larger ribs 11g can extend across the aperture of the support frame 12 to provide extra strength to the smaller sized ribs 11e-f. The pattern of the larger ribs 11g can be aligned with part of the pattern of the smaller sized ribs 11e-f. The ribs 11e-f can extend non-linearly across the aperture of the support frame 12.

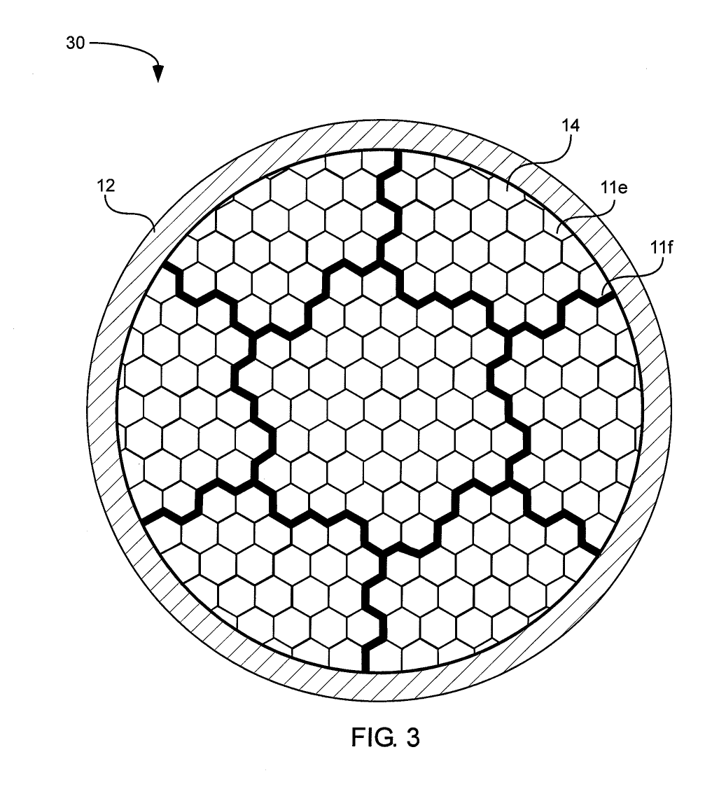

As illustrated in FIG. 3, an x-ray window 30 is shown with ribs 11e-f having at least two different cross-sectional areas. The smallest ribs 11e are formed into repeating hexagonal shapes and define hexagonal-shaped openings. The larger ribs 11f provide extra strength to the smaller sized ribs 11e. The ribs 11e-f can extend non-linearly across the aperture of the support frame 12. The pattern of the larger ribs 11f can be aligned with part of the hexagonal pattern of the smaller sized ribs 11e.

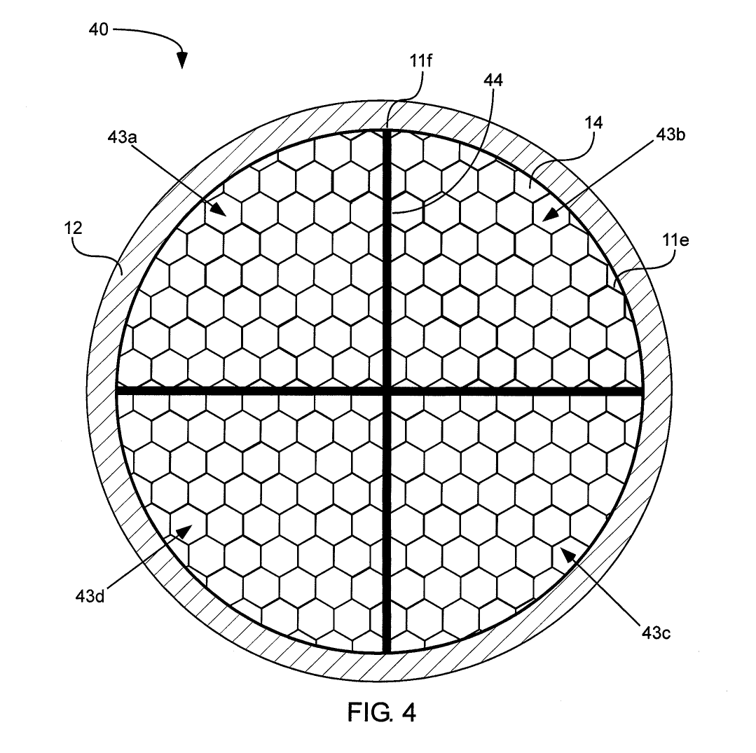

As illustrated in FIG. 4, an x-ray window 40 is shown with ribs 11e-f having at least two different cross-sectional areas. The smallest ribs 11e are formed into repeating hexagonal shapes and define hexagonal-shaped openings. The larger ribs 11f extend across the aperture of the support frame 12, in a cross-shape, to provide extra strength to the smaller sized ribs 11e. The larger-sized ribs 11f, along with the support frame, separate the smaller sized ribs 11e into separate and discrete sections 43a-d. Note that the smaller sized ribs 11e extend non-linearly across the aperture of the support frame 12 while larger sized ribs 11f extend linearly across the support frame 12. A portion of the pattern of the larger sized ribs 11f can be aligned with a portion of a pattern of the smaller sized ribs 11e, such as at location 44. This alignment can optimize strength by continuing with the larger ribs 11f, a portion of a pattern of the smaller ribs 11e.

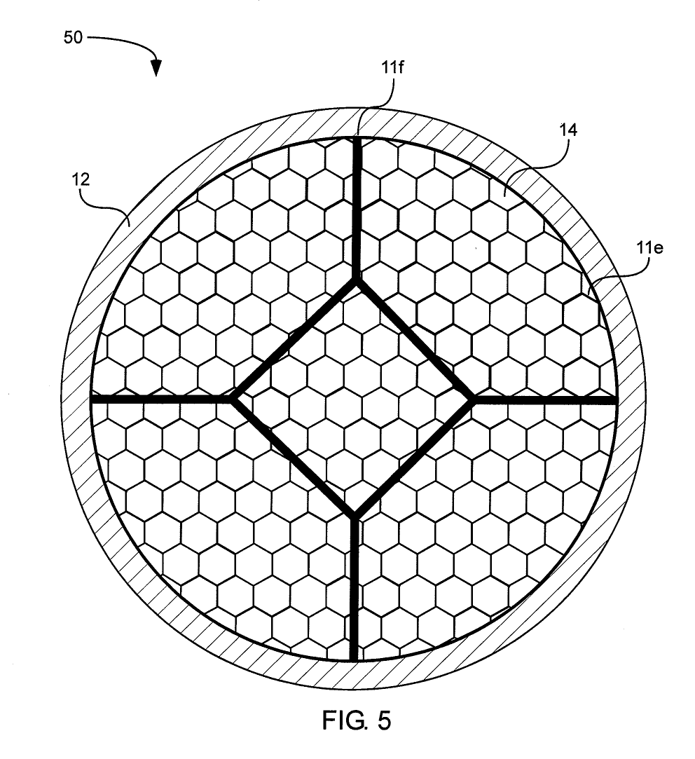

As illustrated in FIG. 5, an x-ray window 50 is shown with ribs 11e-f having at least two different cross-sectional areas and defining hexagonal-shaped openings. The smallest ribs 11e are formed into repeating hexagonal shapes. The larger ribs 11f extend across the aperture of the support frame 12 to provide extra strength to the smaller sized ribs 11e. The ribs 11e-f can extend non-linearly across the aperture of the support frame 12.

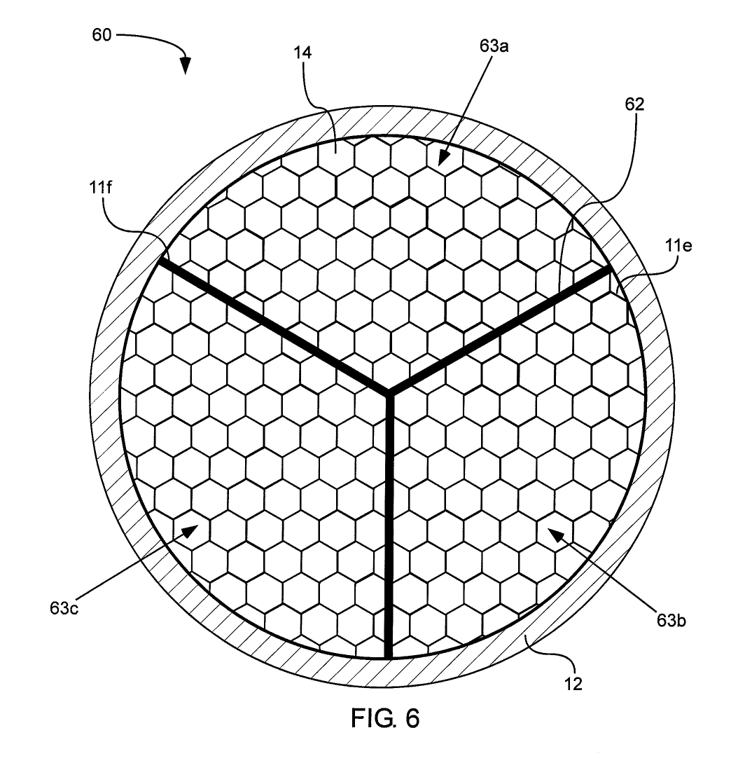

As illustrated in FIG. 6, an x-ray window 60 is shown with ribs 11e-f having at least two different cross-sectional areas. The smallest ribs 11e are formed into repeating hexagonal shapes and define hexagonal-shaped openings. The larger ribs 11f extend across the aperture of the support frame 12 to provide extra strength to the smaller sized ribs 11e. The larger-sized ribs 11f, along with the support frame, separate the smaller sized ribs 11e into separate and discrete sections 63a-c. The ribs 11e-f can extend non-linearly across the aperture of the support frame 12.

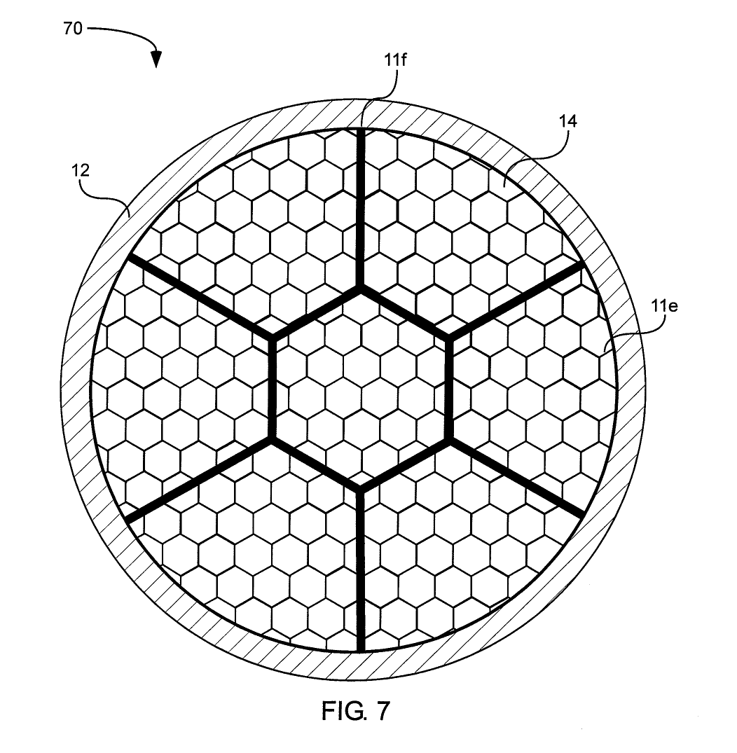

As illustrated in FIG. 7, an x-ray window 70 is shown with ribs 11e-f having at least two different cross-sectional areas. The smallest ribs 11e are formed into repeating hexagonal shapes and define hexagonal-shaped openings. The larger ribs 11f extend across the aperture of the support frame 12 to provide extra strength to the smaller sized ribs 11e. The ribs 11e-f can extend non-linearly across the aperture of the support frame 12.

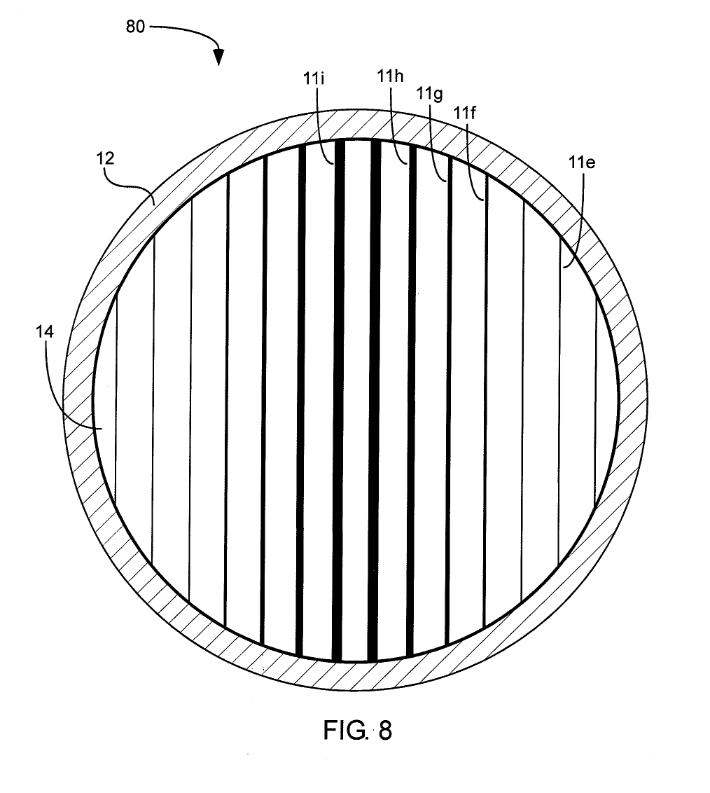

As illustrated in FIG. 8, an x-ray window 80 is shown with substantially parallel ribs 11e-i having at least five different cross-sectional areas. The ribs 11e-i extend linearly from one side of the support frame to an opposing side of the support frame 12. At least one of the larger sized ribs 11i can have a longer length than all smaller sized ribs 11e-h. Also, at least one of the larger sized ribs 11i can span a greater distance across the aperture of the support frame 12 than all smaller sized ribs.

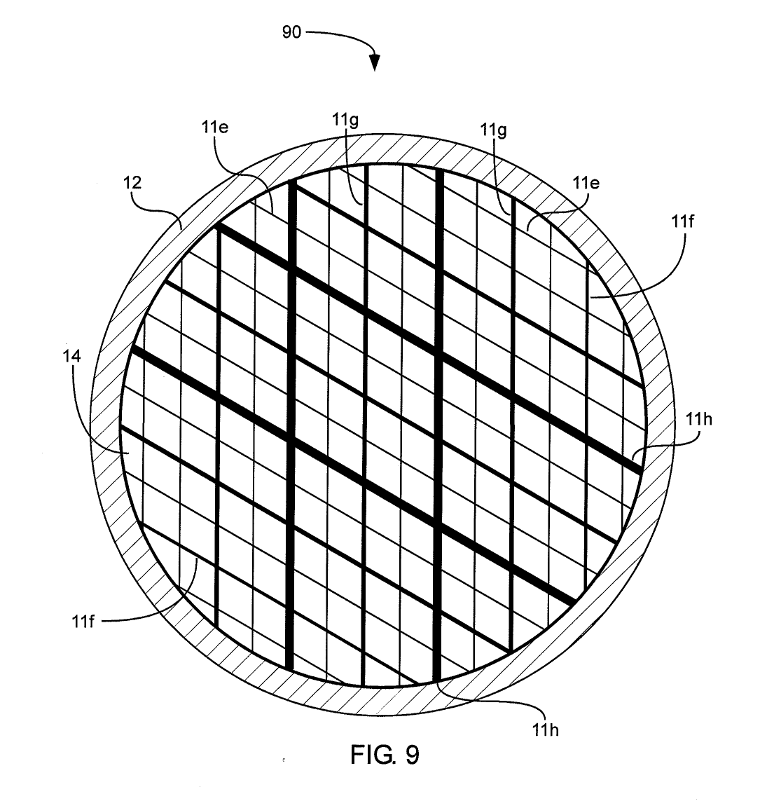

As illustrated in FIG. 9, an x-ray window 90 is shown with ribs 11e-h having at least four different cross-sectional areas. Some of the ribs 11e-h are substantially parallel with respect to each other and some of the ribs 11e-h ribs intersect one another. The intersecting ribs 11e-h can be oriented non-perpendicularly with respect to each other and can define non-rectangular openings 14.

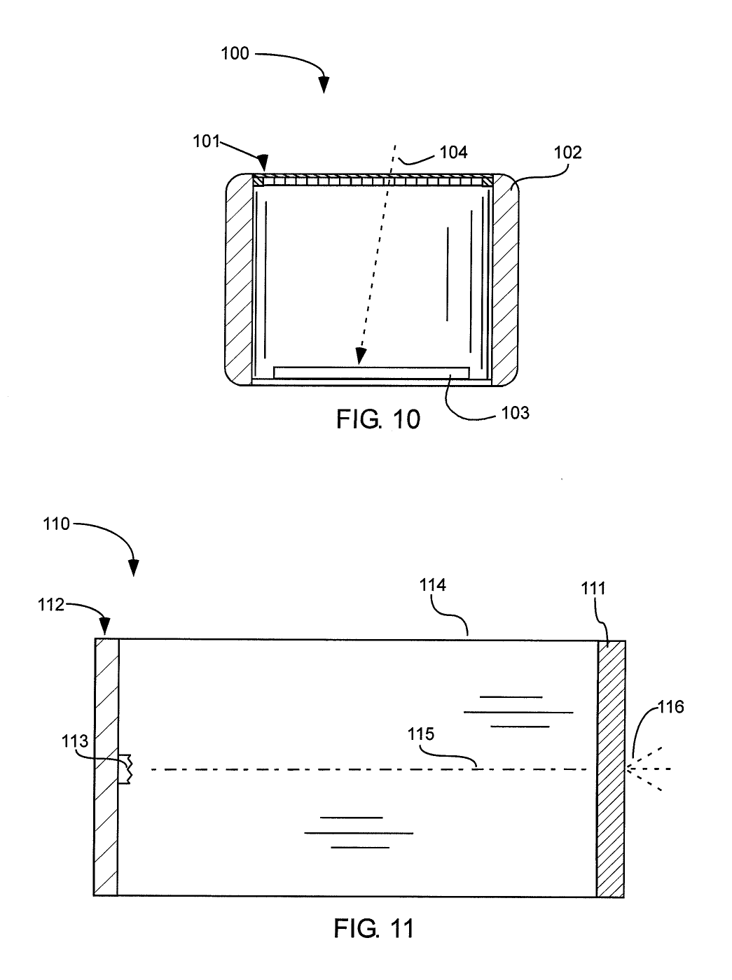

As illustrated in FIG. 10, an x-ray detection system 100 is shown comprising an x-ray window 101 hermetically sealed a mount 102. The x-ray window 101 can be one of the various x-ray window embodiments described herein. An x-ray detector 103 can also be attached to the mount 102. The window 101 can be configured to allow x-rays 104 to impinge upon the detector 103. This may be accomplished by selection of window materials and support structure size to allow for transmission of x-rays and orienting the window 101 and detector 103 such that x-rays 104 passing through the window 101 will impinge upon the detector 103.

As illustrated in FIG. 11, an x-ray source 110 is shown comprising a hermetically sealed enclosure formed by an x-ray window 111, an x-ray tube 114, a cathode 112, and possibly other components not shown. An electron emitter 113 can emit electrons 115 towards the window 111 and the window 111 can be configured to emit x-rays 116 in response to impinging electrons, the x-rays 116 can exit the x-ray source 110. The x-ray window 111 can be one of the various x-ray window embodiments described herein and can have a coating of target material, such as silver or gold, to allow for production of the desired energy of x-rays 116.

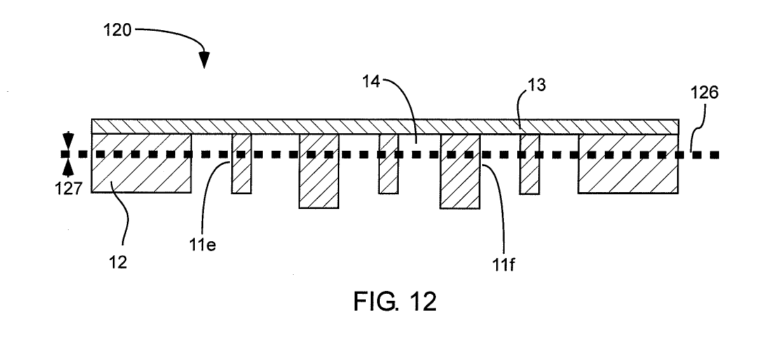

As illustrated in FIG. 12, an x-ray window 120 is shown with a portion of the support frame 12 and a portion of the ribs 11 all disposed in a single plane 126. The plane 126 can be substantially parallel with the film 13 and can have a thickness 127 of less than 5 micrometers.

### How to Make:

The film 13 can be comprised of a material that will result in minimal attenuation of x-rays and/or minimal contamination of the x-ray signal passed through to an x-ray detector or sensor. The film can be comprised of a polymer, graphene, diamond, beryllium, or other suitable material. The window can have a gas barrier film layer disposed over the film. The gas barrier film layer can comprise boron hydride. The film can be attached to the support structure by an adhesive.

The support structure can be comprised of a polymer (including a photosensitive polymer such as a photosensitive polyimide), silicon, graphene, diamond, beryllium, carbon composite, or other suitable material. The support structure can be formed by pattern and etch, ink jet printer or inkjet technology, or laser mill or laser ablation.

In one embodiment, ribs can have a width w between 25 μm and 75 μm and a height h between 25 μm and 75 μm.

In one embodiment, largest ribs can have a width w between about 50 μm and about 250 μm. In another embodiment, smallest ribs can have a width w between about 8 μm and about 30 μm. In another embodiment, intermediate sized ribs can have a width w between about 20 μm and about 50 μm. All ribs in this described in this paragraph can have the same height h or they can be different heights h. All ribs in this described in this paragraph can have heights h as described in the following paragraph.

In one embodiment, largest ribs can have a height h between about 20 μm and about 300 μm. In another embodiment, smallest ribs can have a height h between about 20 μm and about 60 μm. In another embodiment, intermediate sized ribs can have a height h between about 20 μm and about 100 μm. All ribs in this described in this paragraph can have the same width w or they can be different widths. All ribs in this described in this paragraph can have widths as described in the previous paragraph.

In one embodiment, openings 14 between the ribs 11 can take up about 81% to about 90% of a total area within the aperture of the support frame 12. In another embodiment, openings 14 between the ribs 11 can take up about 71% to about 80% of a total area within the aperture of the support frame 12. In another embodiment, openings 14 between the ribs 11 can take up about 91% to about 96% of a total area within the aperture of the support frame 12. Opening 14 area can be dependent on the width w and height h of the ribs 11, the pattern of the ribs, and the number of different sizes of ribs.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A window for allowing transmission of x-rays, comprising:
a) a support frame defining a perimeter and an aperture;
b) a plurality of ribs extending across the aperture of the support frame and carried by the support frame;
c) openings between the plurality of ribs;
d) a film disposed over, carried by, and spanning the plurality of ribs and openings and configured to pass radiation therethrough; and
e) the plurality of ribs having at least two different cross-sectional sizes including at least one larger sized rib with a cross-sectional area that is at least 5% larger than a cross-sectional area of at least one smaller sized rib.

2. The window of claim 1, wherein the at least one larger sized rib has a cross-sectional area that is at least 50% larger than a cross-sectional area of the at least one smaller sized rib.

3. The window of claim 1, wherein the at least one larger sized rib has a cross-sectional area that is at least twice as large as a cross-sectional area of the at least one smaller sized rib.

4. The window of claim 1, wherein the plurality of ribs include at least three different sizes and each larger size has a cross-sectional area that is at least 5% larger than a cross-sectional area of a smaller sized rib.

5. The window of claim 1, wherein the plurality of ribs include at least four different sizes and each larger size has a cross-sectional area that is at least 5% larger than a cross-sectional area of a smaller sized rib.

6. The window of claim 1, wherein the plurality of ribs form multiple hexagonal-shaped structures and define hexagonal-shaped openings.

7. The window of claim 1, wherein the plurality of ribs extend from one side of the support frame to an opposing side and are substantially parallel with respect to each other.

8. The window of claim 1, wherein the plurality of ribs intersect one another.

9. The window of claim 8, wherein the plurality of ribs are oriented non-perpendicularly with respect to each other and define non-rectangular openings.

10. The window of claim 1, wherein at least one larger sized rib has a longer length than all smaller sized ribs.

11. The window of claim 1, wherein at least one larger sized rib spans a greater distance across the aperture of the support frame than all smaller sized ribs.

12. The window of claim 1, wherein the plurality of ribs extend non-linearly across the aperture of the support frame.

13. The window of claim 1, wherein the at least one larger sized rib along with the support frame separate the at least one smaller sized rib into separate and discrete sections.

14. The window of claim 1, wherein tops of the plurality of ribs terminate substantially in a common plane;

15. The window of claim 1, wherein a pattern of the at least one larger sized rib is aligned with a portion of a pattern of the at least one smaller sized rib.

16. The window of claim 1, wherein a portion of a pattern of the at least one larger sized rib is aligned with a portion of a pattern of the at least one smaller sized rib.

17. The window of claim 1, wherein the at least one larger sized rib has a larger width than the at least one smaller sized rib.

18. The window of claim 1, wherein a portion of the support frame and a portion of the plurality of ribs are disposed in a single plane, having a thickness of less than 5 micrometers, which is substantially parallel with the film.

19. The window of claim 1, wherein the film contacts the plurality of ribs.

20. The window of claim 1, further comprising:
a) a mount to which the window is hermetically sealed;
b) an x-ray detector to which the mount is attached; and
c) wherein the window is configured to allow x-rays to impinge upon the detector.

21. The window of claim 1, further comprising:
a) an x-ray source including a hermetically sealed enclosure partially formed by the window and an x-ray tube; and
b) wherein the window is configured to allow x-rays to exit the x-ray source.

22. A window for allowing transmission of x-rays, comprising:
a) a support frame defining a perimeter and an aperture;
b) a plurality of ribs extending across the aperture of the support frame and carried by the support frame, the plurality of ribs having openings therebetween;
c) tops of the plurality of ribs terminate substantially in a common plane;
d) a film disposed over and spanning the plurality of ribs and openings and configured to pass radiation therethrough;
e) the plurality of ribs having at least two different cross-sectional sizes including at least one larger sized rib with a cross-sectional area that is at least 50% larger than a cross-sectional area of at least one smaller sized rib.
f) at least one larger sized rib has a longer length than all of the smaller sized ribs; and
g) at least one larger sized rib spans a greater distance across an aperture of the support frame than at least one of the smaller sized ribs.
